(19) United States
(12) Patent Application Publication
(10) Pub. No.: US 2006/0259334 A1
(43) Pub. Date: Nov. 16, 2006

(54) Pre-purchased air flight miles

(76) Inventor: Kevin R. Walker, Nacogdoches, TX (US)

Correspondence Address: THE MATTHEWS FIRM, 2000 BERING DRIVE, SUITE 700, HOUSTON, TX, 77057, US

(21) Appl. No.: 11/133,689

(22) Filed: May 20, 2005

(51) Int. Cl. G06Q 10/00

(52) U.S. Cl. 705/5

(57) ABSTRACT

A method wherein a user may purchase air travel miles based upon a fixed per seat per mile price such that said purchased miles can be used for future use. Upon purchasing the miles, the user is issued a readable media which stores the customer's information and purchase on it. Upon purchase of new miles or upon utilization and use of miles, information is either subtracted or added to the readable medium. The use may utilize his pre-purchased miles until the point at which he has utilized all the miles in his current account. The purchase miles are stored in a central computer.

### TECHNICAL FIELD

The present system and method relate generally to methods and systems operable for obtaining and utilizing air pass miles which are purchased in advance of air travel. More particularly, it is a system and method involving the use of computer storage of pre-purchase mileage rates and information by which a user can purchase miles of airflight at a given rate at a fixed per seat per mile price for use during a specified period of time.

### BACKGROUND OF THE INVENTION

Air travel has been the most safe and effective means of long distance transportation utilized today. Many airlines though have headed into financial difficulties due to current world affairs and lack of accurate forecasting in air miles usage over given periods of time. Consumers, likewise, have not been purchasing as many air miles as they used to in the past due to both fiscal and safety concerns. Airline industries have forced consumers to purchase airline miles and tickets well in advance of their intended travel dates in order to take advantage of current fares which can change at any given moment. As such, it is difficult for people that have last-minute travel plans and/or rapid decisions in utilizing airfare travel to get good rates. Therefore, a large class of potential air travel users are encouraged to find alternate means of transportation to their destinations. Another result of air travel is that people utilize business and government air travel miles for personal use thereby abusing many company systems of business travel.

The inventive system and method seek to alleviate these problems by utilizing a system involving prepaid miles which can be used by a consumer or a businessman in a given time period thereby freeing up individuals to pre-purchase miles on a per seat per mile basis and utilize them for a variety of flights as opposed to utilizing and buying a prepaid ticket for one particular individual flight. The present system and method also address the misuse of corporate miles for individual use by flagging and giving corporations the ability to quickly and readily see where and how the air pass miles are used. The system and method give flexibility to consumers and businesses to purchase miles at a fixed per seat per mile rate and utilize those miles in quick up-to-the-minute situations to send both individuals and employees to destinations at a given rate thereby avoiding last minute ticketing and financing problems. Since the ticketing purchases are pre-priced per mile, there are no longer any concerns about mile price variances between different cities and destinations.

### BRIEF DESCRIPTION OF THE DRAWINGS

For a further understanding of the nature and objects of the present invention, reference should be had to the following detailed description, taken in conjunction with the accompanying drawings, in which like elements are given the same or analogous reference numbers and wherein:

FIG. 1 illustrates a flow chart concerning the use of the system and method of the invention.

FIG. 2 illustrates a flow chart including the apparatus to be used in accordance to one embodiment of the invention.

FIG. 3 illustrates a flow chart of the procedure utilized by a user to obtain travel miles in accordance with the invention.

### GENERAL DESCRIPTION AND PREFERRED MODE FOR CARRYING OUT THE INVENTION

For a further understanding of the nature, function, and objects of the present invention, reference should now be made to the following detailed description taken in conjunction with the accompanying drawings. Detailed descriptions of the embodiments are provided herein, as well as a mode of carrying out and employing embodiments of the present invention. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples which are deemed illustrative of both the process taught by the present invention and of the product and article of manufacture yielded in accordance with the present invention. It is important to note that throughout all of the embodiments (disclosed below) it should be understood that rearrangement of various functional pathways referred to in this application would be readily apparent to those skilled in the art. “Pre-purchase” or any derivation of the word used for the purposes of this patent means purchasing air travel miles from a store or company in which the air travel miles do not delineate a precise destination, but rather indicate the actual number of air travel miles that can be purchased. “Server” or any derivation of the word used for the purposes of this patent means any electronic or computer system that is capable of storing and sending data information.

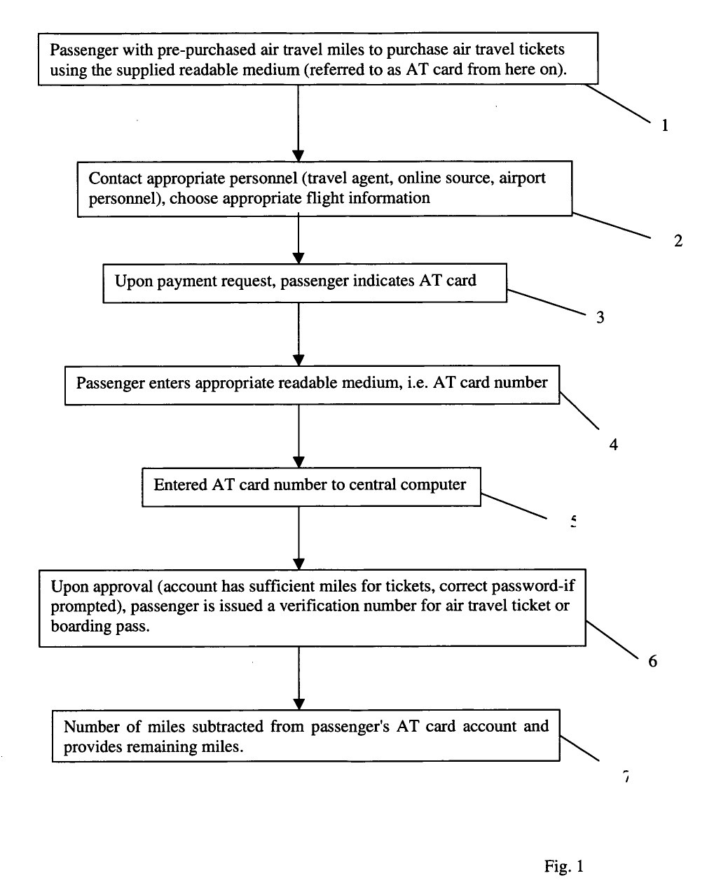

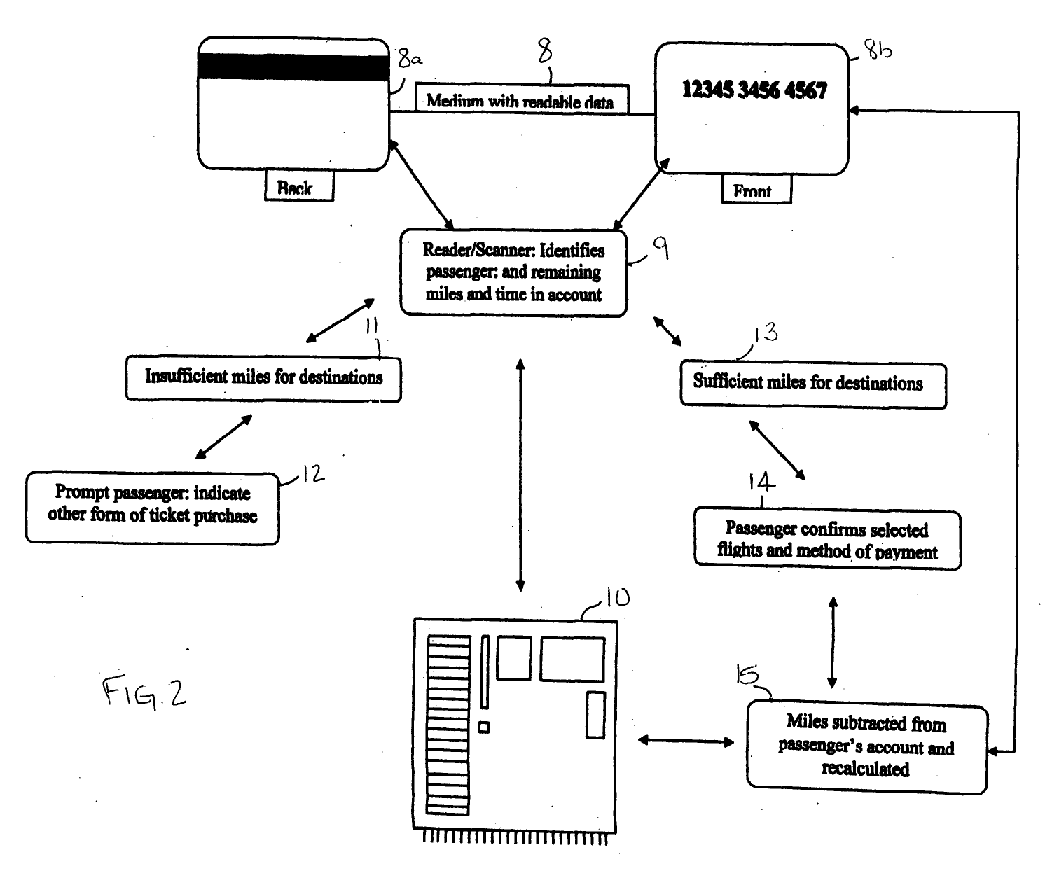

Referring now to the drawings and, more particularly, to FIG. 1, a flow chart is shown, illustrating the use and the method of the present system. Initially a user can go online or visit the locality, or store where the user may pre-purchase air travel miles which are set at a fixed rate per seat per mile, or other method of fixing a price per mile as would be readily known to one skilled in the art. Pre-purchase has been defined in the earlier paragraph. After the user has pre-purchased air travel miles, the user can then utilize the air travel miles to purchase air travel tickets utilizing the supplied readable medium, as seen in step 1. Supplied readable mediums, as used in step 1, for purchasing the air travel tickets, may be, but is not limited to, a bar code strip, an electronic chip associated with an electronic card (such as used in credit cards), a radio wave medium, a radio frequency identification (RFID), fingerprints, retinal scan, personal digital assistance device, mobile telephone, beeper, and/or personal computer. It is important to note that one of ordinarily skill in the art could readily see how to utilize a plurality of potential readable media for storage of purchase air travel tickets and for storage of pre-purchased air travel miles. The readable medium of step 1 stores the data regarding the pre-purchased air travel miles information and/or the purchased air travel ticket information. After a user has purchased air travel tickets or pre-purchased air travel miles, as per step 1, the user can then contact appropriate personnel, which may include, but is not limited to, travel agents, online sources, or airline personnel to obtain the proper and desired flight information and/or flight schedules, as per step 2. After contacting the appropriate personnel, as in step 2, the user would typically be asked for a method of payment to obtain the air travel tickets, as per step 3. The user then enters the appropriate readable medium identification number, as per step 4, wherein the identification is processed into a central computer, as in step 5, and used to retrieve customer information indicative of prepaid purchased air travel miles available to the user. The central computer of step 5 is of the type commonly used to store information such as, but not limited to, a central server, or other computer processing unit. Upon proper information retrieval from the central database computer system 10 (FIG. 2), the user is issued a verification number or boarding pass, step 6, for use in air flight. After the user has entered the information into the central computer, per step 5, and preferably, but not limited to, before being issued the air travel ticket or boarding pass, as per step 6, the total number of available pre-purchased air travel miles that will be used (to and/or from the selected destinations(s)) is subtracted from the user's stored pre-purchased air travel miles in the central database computer system 10 (FIG. 2). Thereby, the user's supplied readable medium would accurately store the corrected miles remaining available to the user, step 7.

FIG. 2 illustrates a flow chart having a medium with readable data 8, which has, in this embodiment, a back 8a with a magnetic strip for storing data and a front 8b with numerical and printed information such as would be used to identify a user's account. The magnetic strip on the back 8a of the medium with readable data acts in a similar manner to that of a credit card, in which the readable data is stored in the magnetic format and can be retrieved for later use. The data stored on the back 8a can be updated to subtract or add additional information and restrictions to the user's account. In use a reader or scanner 9 is used to identify information contained on the readable medium 8 regarding, but not limited to, the user name, the remaining miles in the account, the remaining time to utilize the miles in the account, and other information. If the user seeks to utilize the account, the readable medium 8 is read by scanner 9 and it is determined if there are sufficient miles, step 13 or insufficient miles 11 to reach the destination the user seeks to go. If there are insufficient miles 11 for the user to obtain a ticket for the desired destination, the user is prompted by either a message from the scanner 9 or by airline personnel, to purchase a ticket in another manner or to purchase additional miles for the destination sought, step 12. When the reader or scanner 9 scans the medium readable data 8, the information is transmitted to a central database computer system 10, which will process the information to determine if the passenger has sufficient miles to obtain the ticket for the destination sought. If the user has sufficient miles for the destination sought, as in step 13, the user is prompted by the reader or scanner 9 to select the flight and schedule of travel sought to be obtained including the destination. When the user confirms the flights and the method of payment, in step 14, the miles are then subtracted from the passenger's account and are stored in the central data computer system 10 and in the readable medium 8 and the user's account is recalculated, as per step 15. Upon the recalculation of the user's account, the new updated information is transmitted and stored in the medium with readable data 8.

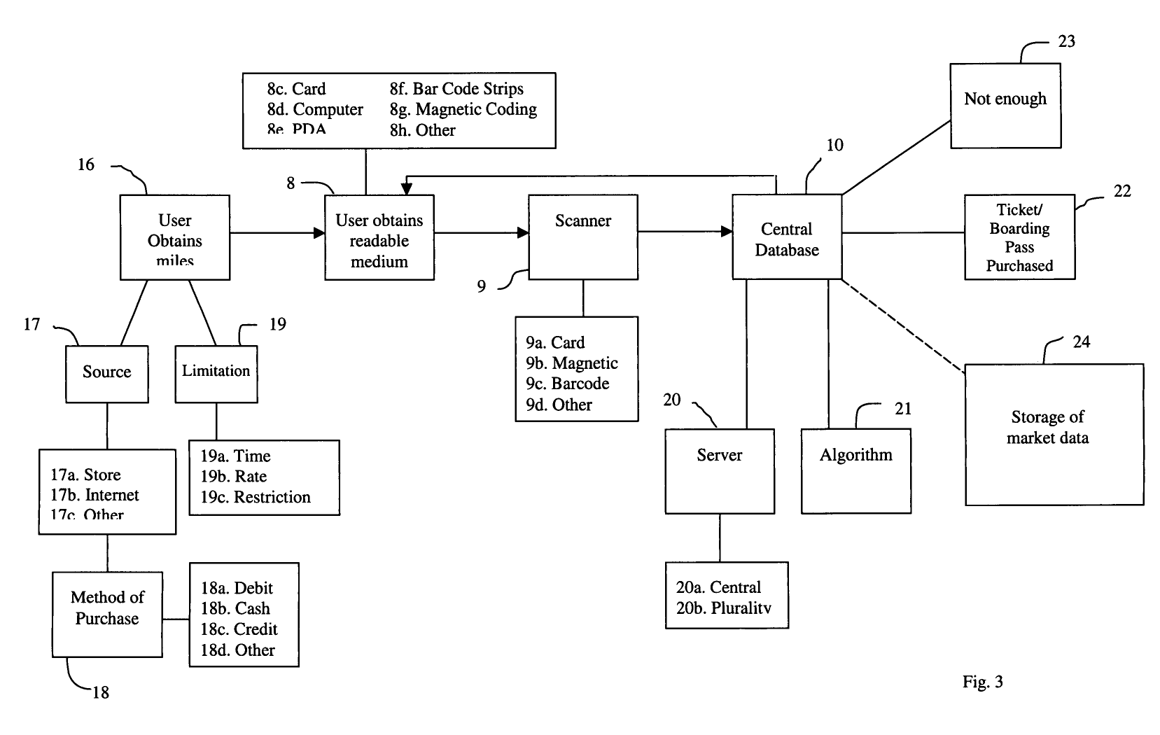

FIG. 3 illustrates a flow chart for the purchase of prepaid miles utilizing the pre-purchased air miles system and method of the present invention. To begin the user obtains miles, as in step 16, from one of a variety of sources 17. The sources may include a local store or kiosk 17a, the internet or internet based purchasing site 17b or, another site 17c which would be conventional for the purchase of air miles. The per seat per mile price may be subject to the total number of miles a user purchases, i.e., the more miles the consumer purchases the lower the price per seat per mile price. Upon purchasing from one of these sources 17, the user may utilize a number of methods to purchase the miles, in step 18, such as but not limited to, a debit card 18a, cash 18b, a credit card 18c, or a plurality of other methods 18d of purchasing. It should be appreciated that a conventional purchaser of air pass miles will readily have knowledge of and find available methods of payment for step 18. When the user obtains the miles, there will typically be limitations on the miles such that the user will have to use them within certain constraints 19. There is, however, no need for any restrictions on the use of the air miles in terms of time for use upon purchase, location or purpose of use. The constraints 19, are in place such that the user is encouraged to utilize the miles within the given time frame and/or the user is discouraged from pre-purchasing miles for use in a manner unintended by the travel provider. As briefly described above, the user can be constrained in terms of time 19a, in which he can utilize the air miles. Such time constraints may include, but are not limited to, restricted holiday use, restricted use within a given time period such as, by example, a 2-year time frame, or restrictions in time in terms of high traffic availability. The user may also be restricted in terms of rate purchase 19b, wherein, these restrictions would include use of miles at a given rate for a given duration of time, or potential location of use restrictions regarding rates. It is important for one skilled in the art to realize that a plurality of restrictions regarding rates of miles purchased may be in place at time of purchasing pre-purchased miles. The user may also be restricted in application of use for pre-purchased miles 19c. Such restrictions may include, but are not limited to, use for business purposes, use only for governnent purposes, or use only for restrictive purposes within the family, for example, use of pre-purchased miles for three members of a family versus an entire family consisting of five members. It should be appreciated by one skilled in the art to realize a plurality of restrictions may and can exist in terms of restrictive use of the obtained air miles. After the user has obtained the pre-purchased air miles, step 16, the user will then obtain the mileage information on a readable medium format 8. The readable medium 8 formats may consist of, but are not limited to, cards 8c, computer programs, codes and storage information 8d, PDAs 8e, bar code strips 8f, and magnetic coding 8g. It is also important to note that one of ordinary skill in the art could conceive of a plurality of other means 8h of readable format data storage information. The information stored on the readable medium 8 is of the format and capable of being retrieved by a scanner 9. The scanner 9 may consist of, but is not limited to, card scanners 9a, magnetic strip scanners 9b, bar code scanners 9c, or plurality of other scanners 9d, such as are used to read PDA information, computer information, or other types of readable medium conventional in the art. (discussed in previous paragraphs). The information that is scanned from the readable medium 8 utilizing a scanner 9 is transmitted to a central database 10. Central database 10 has a server 20, which can relay and transmit all of the information regarding the user's obtained pre-purchased pass miles. The server 20 may include, but is not limited to, a central service unit 20a or a plurality of server units 20b such as are commonly used in the art and to relay and store transmitted information. The central database 10 will also have a computer algorithmic component 21, capable of calculating information such as, but not limited to, miles utilized per pre-purchase miles obtained, miles available to the customer, miles subtracted from previous purchases, rate per mile per purchases, and time variables in connection with purchased miles. It is important to note that the central database 10 is capable of transmitting data back to the readable medium such that the readable medium 8 can store modifications and changes are made in the user's account regarding pre-purchased miles. If the central database 10 determines that the user has enough miles to purchase the ticket desired then the ticket/boarding pass is purchased, as in step 22. Likewise, if the central database 10 determines that there are not sufficient miles for the ticket to be purchased, then the ticket is not issued and appropriate information is sent to the user readable medium 8 indicating that the user does not have the appropriate number of miles necessary to purchase the ticket, step 23. Optionally, the central database may also provide information or store information regarding customer preferences and customer buying trends to be utilized in later promotions and reducing potential air pass mile fees, step 24.

It may be seen from the preceding description that a new and improved air pass miles purchase system and method has been provided. Although very specific examples have been described and disclosed, the invention of the instant application is considered to comprise and is intended to comprise any equivalent structure and may be constructed in many different ways to function and operate in the general manner as explained hereinbefore. Accordingly, it is noted that the embodiments of the new and improved air pass miles purchase system and method described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. A method of purchasing air travel miles in advance of air travel comprising:
fixing a per seat per mile price;
purchasing travel miles based on the fixed per seat per mile price;
storing the purchased miles on a readable media;
connecting the readable media to a data computer system for information storage;
constructing the readable media from a readable media consisting of an element selected from the group of an electronic card, magnetic strip, Radio frequency identification, a barcode strip, an electronic trip, and/or a beeper, and combinations thereof;
retrieving said stored information from the computer system for information storage; and
utilizing said stored information to obtain air mile tickets; whereby the user can access the stored purchased miles to purchase an air travel ticket to go to a requested air flight destination.

2. The method of claim 1, further comprising enabling the data computer system to be operable to read the readable media.

3. The method of claim 1, further comprising determining the amount of purchased miles remaining in an account stored in said computer system through use of a computer program and/or an algorithm.

4. The method of claim 1, further comprising adding or subtracting purchased miles in the computer system.

5. The method of claim 1, further comprising purchasing the air pass miles utilizing a purchase method consisting of an element selected from the group of a credit card, ATM card, checking card, personal check, cash, business check, government check, money order, and combinations thereof.

6. The method of claim 1, further comprising eliminating restrictive times for utilizing purchased air travel miles.

7. The method of claim 1, further comprising limiting the time period to utilize the purchased air miles at the purchased rate.

8. The method of claim 7, further comprising purchasing additional miles, whereby additional purchased miles are utilized with purchased miles that exceed the initial purchase time period.

9. The method of claim 1, further comprising creating the computer system of a plurality of central servers for storage of purchase mile information.

10. The method of claim 1, further comprising purchasing air pass purchase miles directly from an airline company.

11. The method of claim 1, further comprising limiting the use of purchased air travel miles to individual use, limited business use, or limited government use.

12. The method of claim 1, further comprising tagging or coding the purchased air miles for intended use.

13. The method of claim 1, further comprising marking the purchased air pass miles with indicia, wherein the indicia can display the number of miles, personal identification, and/or the intended use of the air pass miles.

14. The method of claim 1, further comprising purchasing the air pass miles utilizing a purchase air travel site consisting of an element selected from the group of online travel sites, travel agents, telephone, in person directly through and airline, and combinations thereof.

15. A system for purchasing air travel miles comprising;
a medium with readable data;
a reader or scanner capable of reading or scanning the medium with readable data;
the readable media is from a group of readable media consisting of an element selected from the group of an electronic card, magnetic strip, Radio frequency identification, a barcode strip, an electronic trip, and/or a beeper, and combinations thereof;
a central data base computer system whereby purchased miles are stored on the readable media and the reader or scanner is capable of reading or scanning the readable media for information; and the information is transmitted to the central database computer for storage and retrieval;
whereby the information may be used to obtain purchase mile tickets; and,
whereby the user can access the stored miles to purchase tickets to go to selected air flight destinations.

16. The system of claim 15, whereby said computer storage system further comprises a reader operable to read data on a medium.

17. The system of claim 16, further comprising the computer system can determine the amount of miles remaining in a user account.

18. The system of claim 15, whereby the computer system further comprises a central computer which can add or subtract purchased miles as appropriate.

19. The system of claim 15, further comprising the purchased miles are purchased utilizing a purchase device consisting of an element selected from the group of a credit card, ATM card, checking card, personal check, cash, business check, government check, money order, and combinations thereof.

20. The system of claim 15, further comprising the purchased air travel miles are not subject to time restrictions.

21. The system of claim 15, further comprising the purchased air miles at the purchased rate are restricted to use in a given time frame.

22. The system of claim 21, further comprising additional purchase miles can be purchased for use with said purchase miles that exceed said time period.

23. The system of claim 15, further comprising the central data base computer for storage of purchase mile information contains a plurality of servers.

24. The system of claim 15, whereby the purchased miles are purchased directly from an airline company.

25. The system of claim 15, wherein said purchased air travel miles further comprise the prepaid travel miles are limited to individual use, limited business use, or limited government use.

26. The system of claim 15, further comprising the purchased air pass miles has indicia wherein the indicia indicates the number of miles, personal identification, and/or the intended use of said miles.

27. The system of claim 15, further comprising the purchased miles are purchased from a site consisting of an element selected from the group of online travel sites, travel agents, telephone, in person directly through and airline, and combinations thereof.
